(19) United States
(12) Patent Application Publication
(10) Pub. No.: US 2014/0011284 A1
(43) Pub. Date: Jan. 9, 2014

(54) METHOD AND KIT FOR ANALYZING SAMPLES

(71) Applicant: BIOMOTIF AB, Danderyd (SE)

(72) Inventors: Thorleif LAVOLD, Stockholm (SE); Juan ASTORGA WELLS, Johanneshov (SE); Peter MICHELSEN, Staffanstorp (SE); IAN ALAN NICHOLLS, Kalmar (SE)

(73) Assignee: BIOMOTIF AB, Danderyd (SE)

(21) Appl. No.: 14/026,455

(22) Filed: Sep. 13, 2013

Related U.S. Application Data
(63) Continuation of application No. PCT/SE2012/050297, filed on Mar. 16, 2012.

(51) Int. Cl. G01N 30/96

(52) U.S. Cl. CPC G01N 30/96
USPC 436/120; 436/161

(57) ABSTRACT

The present invention relates to a method tor enriching and/or separating and/or immobilizing an analyte of interest comprising bringing an analyte of interest into contact with a derivatizing agent; incubating said analyte with said derivatizing agent, thereby incorporating a sulphonic acid group or as analogue thereof into the molecular structure of mo analyte of interest; bringing the analyte of interest into contact with a molecularly imprinted polymer with selective affinity foe a sulphonic acid group or an analogue thereof; and enriching and/or separating and/or immobilizing the analyte of interest by nee of the molecularly imprinted polymer. Further disclosed is a kit comprising a derivatizing agent, which contains a sulphonic group or an analogue thereof and a reactive group for creating a covalent bond between said derivatizing agent nod an analyte of interest, and a molecularly imprinted polymer with selective affinity for a sulphonic acid group or an analogue thereof.

### BACKGROUND OF THE INVENTION

Molecularly imprinted polymers (MIP) are synthetic polymers having chemical affinity for a target, analyte having similar characteristics to biological antibody/antigen or enzyme/substrate systems. MIPs are produced by a technique called molecular imprinting, which creates template-shaped cavities in polymer matrices with memory of the template molecules to be used in molecular recognition. This technique is based on the system used by enzymes for substrate recognition, which is called the “lock and key” model. The active binding site of the imprinted material has a unique three-dimensional chemical structure that has a high affinity for the substrate (analyte). With these characteristics, MIPs can be used to separate and/or concentrate and/or isolate a particular set of analytes. Molecularly imprinted polymers are well known in the art and they have been described in numerous scientific articles (Biosensors and Bioelectronic 2009 25(3):543-52: Journal of Separation Science 2009 32(5-6):799-812, Analytical Chimica Acta 2007 2 594(2) 147-61.)

The following is a brief and non-limiting example of bow to produce MIPs. The aim of this procedure is to produce a highly cross-linked polymeric phase with predetermined selectivity for a single analyte or a group of structurally related molecules. For producing MIP by non-covalent imprinting, a template molecule is dissolves together with one or more functional monomers. In this step, a spontaneous formation of template/functional-monomers complexes occurs. This step is followed by the addition of cross-linking monomers, which results in polymerization, and the template molecule is subsequently removed by extensive washing. The resulting MIP will contain specific cavities that are sterically and chemically complementary to the template.

The binding of the analyte to the MIP-bonded phase is primarily made through non-covalent bonding i.e., hydrogen bonding. Secondary bonding such as electrostatic interaction, such as n-n and n-n interaction, hydrophobic bonding, can also participate dependent on the chemical nature of the analyte and/or MIP-phase.

At present, much of the focus has been in creating MIPs for individual analytes using templates with similar functionalities as the analyte(s). However, this may be considered very laborious and not cost-effective, since a novel and specific MIP must be synthetised for each analyte. In addition, the bonding strength strongly depends on the sufficient existence of sufficient donor- and/or acceptor sites of the analyte or MIP phase, and therefore the quality of the MIP is strongly dependent on the molecular structure of the analyte.

### Definitions

All terms used in the present specification are intended to have the meaning usually given to them in the art. For the sake of clarity, some terms are also defined below.

The expression “a sulphonic acid group or an analogue thereof” shall be construed as meaning a sulphonic acid group or an aromatic sulphonic acid derivate (phenyl- or polyphenyl-sulphonic acid derivates).

### BRIEF DESCRIPTION OF THE DRAWINGS

FIG. 1. Schematic representation of analyte-derivatisation according to the invention, enrichment/purification using a derivatised-analyte directed MIP. A sample containing the analyte 1 and a contaminant 3 is mixed with a derivatising agent 2 (FIG. 1A). A derivatized analyte 4 is formed after an appropriate incubation period (FIG. 1B). A molecularly imprinted polymer substrate 5, having the binding site 6 with affinity towards the derivatised analyte 4 (FIG. 1C), is mixed with the derivatised sample (FIG. 1D). The derivatised analyte 4 binds to the binding site 6 of the molecularly imprinted polymer 5 (FIG. 1E). Unbound contaminant 3 is washed away, leaving the derivatised analyte/molecularly imprinted polymer complex 7 (FIGS. 1E-1F). The derivatised analyte 4 is released from the molecularly imprinted polymer 5 resulting in a purified fraction of the analyte of interest 4 (FIG. 1G).

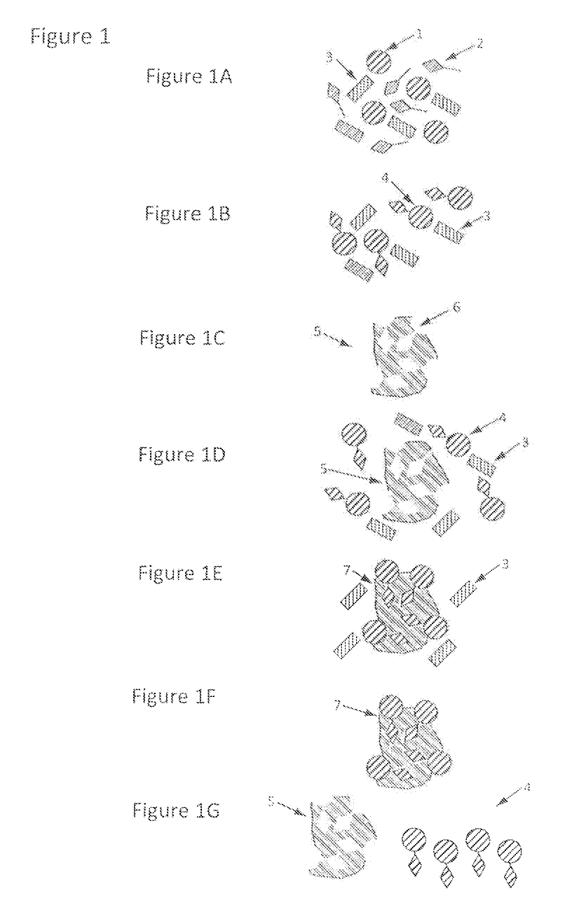

FIG. 2. Schematic representation of on-substrate analyte-derivatisation. according to the invention, where derivatization and enrichment/purification is performed on an already prepared derivatising agent/molecularly imprinted polymer complex. The derivatising agent 2 and the molecularly imprinted polymer substrate 5, having the binding site 6, (FIG. 2A) are mixed in order to obtain the molecularly imprinted polymer/derivatising agent complex 8 (FIG. 2B). Then, the molecularly imprinted polymer/derivatising agent complex 8 is mixed with the sample containing analyte 1 and contaminant 3 (FIG. 2C). This is followed by the reaction between the molecularly imprinted polymer/derivatising agent complex 8 and the analyte 1 which forms the molecularly imprinted polymer/derivatised analyte complex 7 (analyte 1 forms a covalent bond with the molecularly imprinted polymer/derivatising agent complex 8, as seen in FIG. 2D). Unbound contaminant 3 is washed away, leaving the molecularly imprinted polymer/derivatised analyte complex 7 alone (FIG. 2E). The derivatised analyte 4 is released from the molecularly imprinted polymer 5 resulting in a purified fraction of the derivatized analyte of interest 4 (FIG. 2F).

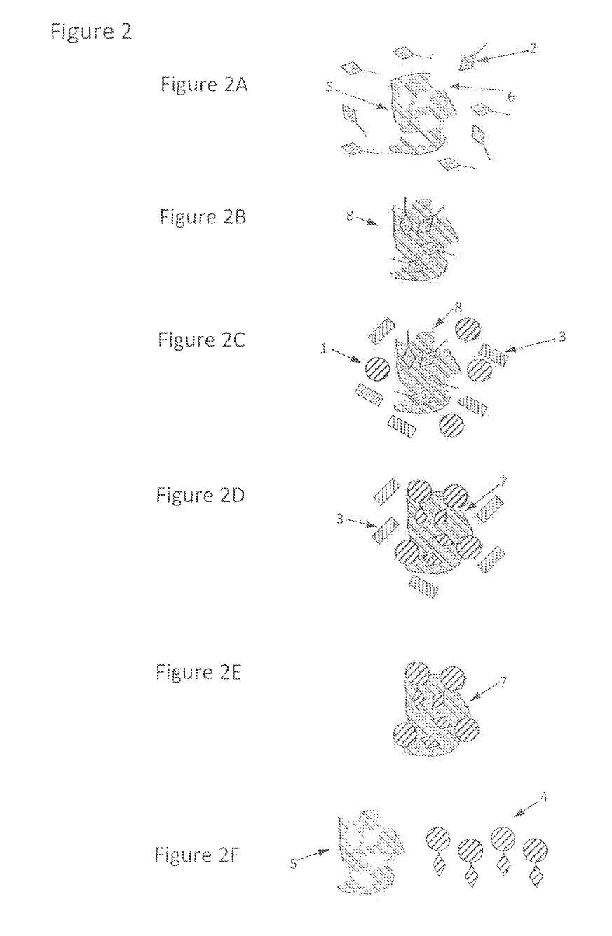

### SUMMARY OF THE INVENTION

In order to solve the problems mentioned above, the present invention combines the use of molecularly imprinted polymers directed towards generic derivatising agents to enrich and/or separate and/or immobilise analyses. The generic-chemical group incorporated into the chemical structure of the analyte is a sulphonic acid or a sulphonic acid derivate. The invention provides a methodology where a generic group of molecularly imprinted polymers can be used to enrich and/or separate and/or immobilise a broad variety of analytes.

The present invention relates to a method for enriching and/or separating and/or immobilizing an analyte of interest comprising:

bringing an analyte of interest into contact with a derivatizing agent;
incubating said analyte with said derivatizing agent, thereby incorporating a sulphonic acid group or an analogue thereof info the molecular structure of the analyte of interest;
bringing the analyte of interest into contact with a molecularly imprinted polymer with selective affinity for a sulphonic acid group or an analogue thereof; and
enriching and/or separating and/or immobilizing the analyte of interest by use of the molecularly imprinted polymer.

According to an embodiment of the method of the present invention, said derivatizing agent contains tire sulphonic group or an analogue thereof and a reactive group for creating a covalent bond between, said derivatizing agent and said analyte of interest.

In an embodiment of the method, said derivatizing agent has the formula R₁SO₃H or consists of a salt thereof, where R₁ is an organic compound comprising an aromatic ring, preferably a phenyl ring, or a polyaromatic compound, preferably antranyl or phenanyl.

In an embodiment of the method, said reactive group of said derivatizing agent has a formula selected from —NH₂, —NHNH₂, —COOH, —COCl, —CHO, —NCO, and —NCS.

In an embodiment of the method, said analyte of interest and said derivatizing agent are brought into contact to form a covalent complex between the analyte of interest and the derivatizing agent. Therafter, said analyte of interest/derivatizing agent covalent complex may then be brought into contact, with said molecularly imprinted polymer, thereby forming a non-covalent complex between the analyte of interest/derivatizing agent complex and the molecularly imprinted polymer in an alternative embodiment of the method, said derivatizing agent and said molecularly imprinted polymer are brought into contact, to form a non-covalent complex between the derivatizing agent and the molecularly imprinted polymer. Thereafter, said, derivatizing agent/molecularly imprinted polymer non-covalent complex is brought into contact with said analyte of interest, thereby forming a covalent complex between said analyte of interest and the derivatizing agent moiety of the derivatizing agent/molecularly imprinted polymer non-covalent complex.

In an embodiment of the method, the analyte of interest/derivatizing agent complex is released from the molecularly imprinted polymer by means of the use of organic solvents and/or acidic or basic pH conditions and/or the use of inorganic salts. In an embodiment of the method, the molecularly imprinted polymer is packed into a column.

In an embodiment of the method, the molecularly imprinted polymer is linked or attached non-covalently or covalently to, or spotted on, a surface for analysis by matrix assisted laser desorption ionization mass spectrometry (MALDI-MS) in another embodiment of the method, the molecularly imprinted polymer is linked or attached non-covalently or covalently to a surface for analysis by a quarts crystal microbalance sensor or a surface plasmon resonance sensor or magnetic beads. In an embodiment of the method, said derivatized analyte is farther concentrated and/or isolated and/or separated by electrocapture. Electrocapture is a method of capturing charged molecules travelling in a flow stream, as described in WO2004056597.

In an embodiment of the method, the derivatized analyte is further analyzed by mass spectrometry.

The present invention further relates to a kit for performing the above-described method, said kit comprising a derivatizing agent, which contains a sulphonic group or an analogue thereof and a reactive group for creating a covalent bond between said derivatizing agent and an analyte of interest, and a molecularly imprinted polymer with selective affinity for a sulphonic acid group or an analogue thereof.

In addition, the present invention relates to a kit for performing the above-described method of MALDI-MS, said kid comprising a derivatizing agent, which contains a sulphonic group or an analogue thereof and reactive group for creating a covalent bond between said derivatising agent and an analyte of interest, and a MALDI-MS plate onto which a molecularly imprinted polymer with selective affinity for a sulphonic acid group or an analogue is deposited.

### DESCRIPTION OF THE INVENTION

The generic handle used according to the invention has a particular chemical structure that improves and/or facilitates and/or enhances the interaction, between the generic handle and the MIP, as well as another chemical group that covalently binds the analyte to the generic handle.

The generic handle related to the invention (which will be incorporated into the chemical structure of the analyte) is a sulphonic acid group or an analogue thereof, the analogue thereof being an aromatic sulphonic acid derivate (phenyl- or polyphenyl-sulphonic acid derivates).

### Sulphonic Group as a Generic Handle:

The generic handle is a sulphonic group, which according to the present invention is the group that is most important in order to bind to the MIP phase. This so-called MIP interaction group is further described below.

### Aromatic Sulphonic Acid Derivates as a Generic Handler

In this case, the generic handle is an aryl sulphonate (or polyphenyl sulphonate) derivate which has two distinct functional groups (in addition to the aromatic core) in its molecular structure: a MIP interaction group that is responsible for binding the MIP to the generic handle, and a derivatising group that is responsible for covalently binding the analyte to the generic handle.

Considering aryl sulphonates derivates, the generic handle has the following general structure, Formula I:

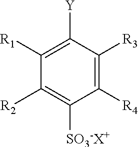

Formula I. General structure of the derivatisation reagent, where Y is the derivatising group and SO₃—X⁺ is the MIP interaction group (R₁ to R₄ are described below).
MIP interaction group. The present invention uses a particular chemical group designed to be optimal for a series of hydrogen-donor groups available for interacting with the MIP. The generic handle contains a sulphonic group (—SO₃—) having as much as 5 donor sites available for MIP bonding. On the other hand, the MIP is designed to have a number of hydrogen acceptor sites that improves and/or facilitates and/or enchances the interaction with the generic handle. The existence of multiple donor sites improves and/or facilitates and/or enchances the bonding properties of the MIP to the generic handle.

Another advantage of the present invention is that the presence of the sulphonic group into the chemical structure of the analyte can increase the sensitivity when analysed by some analytical instrumentation. For example, molecules with sulphonic groups are easily detected by negative electrospray ionization mass spectrometry resulting in high sensitivity mass spectrometrical analysis. Furthermore, the generic handles described in the present application have been chosen to produce high yields of derivatised analytes in a cost-effective manner.
Derivatising group. The present invention utilises a series of derivatising groups that allows linking (via covalent binding) of the analyte to the generic handle. The structure of the derivatising group is variable and it will depend on the molecular structure of the analyte. Non-limiting examples of the derivatising group is NH₂, NHNH₂, —COOH; COCl, COOR, —CHO, —NCO, —NCS.

The presently disclosed method to “tag” (i.e. derivatize) molecules, such as for example peptides, sugars, steroids and vitamins, and subsequently capture the molecules by so-called Epitope imprinting, by using the generic MIP-phase/surface/columns according to the present invention, will open new possibilities in many areas.

This method to fish out and capture specific molecules from a complex matrix at lower levels of detection, will open up new applications in for example biomarker analysis, forensic science, toxin detection, environmental analysis, pharmaceutical analysis, clinical analysis and in the field of diagnostics.

### Example 1

This example comprises at least five steps. First, the generic handle is incorporated into the chemical structure of the analyte (by derivatisation). Second, the derivatised analyte is brought, into contact with the handle-binding molecularly imprinted polymer. Third, the derivatised analyte binds and/or interacts with the handle-binding molecularly imprinted polymer. Fourth, the derivatised analyte is released and/or eluted from the handle-binding molecularly imprinted polymer. Fifth, the derivatised analyte is analysed.

First step, derivatisation. The generic handle is covalently attached to the analyte by derivatising the analyte with a proper derivatisation agent (Formula I). The derivatisation agents are aryl sulphonate(s) having a reactive group that form a covalent bond with the analyte of interest. The derivatisation reagent has the following general structure, Formula I:

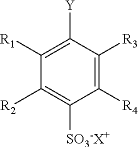

### Formula I. General Structure of the Derivatisation Reagent

### X⁺ is Li⁺, Na⁺ or K⁺;

R₁ is H, CₙH₂ₙ₊₁ (where n=1-4), C₆H₁₁, C₆H₅, C₁₀H₇, C₆H₄(CₙH₂ₙ₊₁), C₆H₄₋ₘ(CₙH₂ₙ₊₂)ₘ (where m=1-4), NO₂, F, Cl, Br, I, O—(CₙH₂ₙ₊₁), O(CₙH₂ₙO)ₙCₙH₂ₙ₊₃)₂, CON(CₙH₂ₙ₊₁)₂, CO₂(CₙH₂ₙ₊₁), CO₂X⁺, CO₂H, (CH₂)ₙCON(CₙH₂ₙ₊₁)₂, (CH₂)ₙCO₂(CₙH₂ₙ₊₁), (CH₂)ₙCO₂−X⁺, (CH₂)ₙCO₂H, N(CₙH₂ₙ₊₁)₂, CO(CₙH₂ₙ₊₁), O₂C(CₙH₂ₙ₊₁), C₆H₃O₂(CH₂)ₙ, C₆H₃₋ₖ[O(CₙH₂ₙ₊₁)]ₖ where k=1-5), C₅H₄N, SO₃·X⁺, SO₃(CₙH_{2n 1}) or SO₂(CₙH₂ₙ₊₁); and
R₂, R₃, R₄=R₁; R₂, R₃, R₄≠R₁ (i.e. R₂, R₃, R₄ could be any group or combination thereof).

Y is selected from NH₂, NHNH₂, —COOH; COCl, COOR, —CHO, —NCO, and —NCS, in addition, the core aromatic ring shown in Formula 1 could also be any aromatic moiety such as an antracene derivative and/or a phenantrene derivative having Y and [—SO₃X] at any position.

### Non-Limiting Examples of Derivatization Agents

Examples of functional group Y of the derivatisation reagent (Table 1), that can bind to an analyte with a functional group of interest by derivatisation and be captured by MIP are shown in Table 1.

TABLE 1

| Y | Functional group of the analyte |
|---|---|
| —NHNH₂ | —CO—; —COOH: —PO₄H_{2;} Sugars |
| | (aldoses and ketoses) |
| —COOH | —OH; —SH; —NH₂ |
| —NCS/—NCO | Edman Degradation; —OH; —SH; —NH₂; |
| | amino acids; oxíranes |
| —NH₂ | —NCO; —NCS; Ar—OH |
| —CHO | Diketones |

### Experimental Examples of Derivatisations

All derivatives were submitted to negative electrospray ionisation MS and MS/MS for characterisation of their identity and obtained molecular weights were in accordance with the theoretical molecular weights. The following examples are given:

### 2′,4′,6′-Trihydroxyacetophenone

A. A stock solution of the analyte 2′,4′,6′-Trihydroxyacetophenone was made by dissolving 2 mg in 10 mL of a mixture of water with 0.1% formic acid and acetonitrile 50:50 (V/V).
B. A saturated solution of sulfanilic acid in 0.1% formic acid and acetonitrile.
C. A solution of 3 mg/mL of sodium nitrite.

To 100 uL of A was added 100 uL of B and 100 uL of C and diluted with 500 ul of 0.1% formic acid. The mixture was allowed to stand at room temperature for 15 minutes before being analyzed by LC-MS analysis. The derivative was found to be stable in solution>20 hours. Analysis by mass spectrometry: A number of diluted samples injections were made. The final dilution of the derivative was 1,000,000 times, corresponding to 0.25 pg injected or 0.7 fmol utilising full scars with a Quattro-LC. Derivatisation of the analyte 2′,4′,6′-Trihydroxyacetophenone gave 100 times more sensitivity upon MS analysis compared to the analyte not being derivatized.

### Carboxylic Acids (Weakly Ionised Compounds), Lactate

The derivatisation uses 2 solutions apart from the analyte (in this case Lactate):

Solution A: Sulfanilic acid hydrazine 40 mg in 1.5 mL water:ethanol 1:1 (v/v)
Solution B: 40 mg of EDC (1-Ethyl-3-(3-dimethylamino-propyl)carbodiimide) in 2 mL ethanol and 2 mL of 3% (v/v) pyridine in ethanol.
Solution C (analyte): 0.1 mg/mL of Lactate in water

The derivatisation is made by mixing 100 uL of solution C, 200 uL of solution A and 400 uL of solution B. The mixture is heated at 60° C. for 20 minutes.

### Aldehydes

The same procedure as described for carboxylic acids (above) but without the addition of Solution B.

### Examples of Enhanced MS Detection

All derivatives were submitted to negative electrospray ionisation MS and MS/MS for characterisation of their identity and obtained molecular weights were in accordance with the theoretical molecular weights. The following examples are given, on the derivatisation of octylamine:

Synthesis of the derivatising agent (Solution A): A stock solution of sulphanilic acid was made; 16 mg was dissolved in 100 mL of 5% water in acetonitrile. To that solution 200 uL TEA (methyl amine) was added followed by thiophosgene 70 uL (d=1.5)=105 mg in 100 ml acetonitrile (B), forming the thioisocyanate derivate shown in Formula II below. This solution had a concentration of 0.82 mmol/uL.

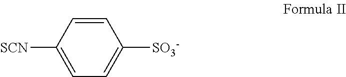

Analyte (Solution B): Octylamine was dissolved in 100 mL 5% water in acetonitrile at final concentration of 7.75 mmol/uL

Derivatisation reaction: 105 uL of octylamine (solution B) was mixed with 1000 uL of Solution A. After sonicating for 30 minutes a derivatised octylamine is obtained (Formula III). The sample was submitted to HPLC/MS using a short LC column with a mobile phase of 75% ACN and 25% water with 0.01% Acetic acid at a flow rate of 0.2 mL/min, utilising negative ES in full scan mode.

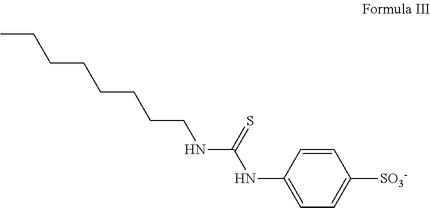

The sensitivity was 0.16 pmole injected with a S/N=10, which it is at least a 50-fold increase in sensitivity (compared to the underivatised sample).

Second and third step: derivatized analyte/molecularly imprinted polymer interaction. A sample containing the analytes is injected or deposited or displaced into columns packed with molecularly imprinted polymer-beads (HPLC columns, spin-column, solid-chase columns and/or heads incorporated into pipetting tips). The sample injected or deposited or displaced into columns is brought into contact with the molecularly imprinted polymer where the interaction takes place. Compounds that do not interact with the molecularly imprinted polymer are washed away by continuous washing (using an appropriate buffer).

In the case that the MIP is located on an open surface (such as a coating material) the sample can be deposited by pipetting, in the case that the MIP is located at the surface in a chamber and/or fluidic cell and/or microfluidic device (e.g. surface plasmon resonance or quartz crystal microbalance) the sample can be injected by flow injection.

Release and analysis. The derivatised analyte is released by using a solvent or a solvent mixture and/or a solution capable of selectively competing for the interactions binding the analyte and/or by modifying the ionization of the analyte of interest and/or the MIP (e.g. pH change, acid or basic conditions). Solvents used could be mixtures of acetonitrile/water or methanol water. Once the derivatised analyte of interest is released, it can be collected for further analysis or injected online to a mass spectrometer (ESI-MS or LC-MS/MS).

1. A method for enriching and/or separating and/or immobilizing an analyte of interest comprising:
bringing an analyte of interest into contact with a derivatizing agent; incubating said analyte with said derivatizing agent, thereby incorporating a sulphonic acid group or an analogue thereof into the molecular structure of the analyte of interest;
bringing the analyte of interest into contact with a molecularly imprinted polymer with selective affinity for a sulphonic acid group or an analogue thereof; and
enriching and/or separating and/or immobilizing the analyte of interest by use of the molecularly imprinted polymer.

2. A method according to claim 1 wherein said derivatizing agent contains the sulphonic group or an analogue thereof and a reactive group for creating a covalent bond between said derivatizing agent and said analyte of interest.

3. A method according to claim 1 wherein said derivatizing agent has the formula R₁SO₃H or consists of a salt thereof, where R₁ is an organic compound comprising an aromatic ring, preferably a phenyl ring, or a polyaromatic compound, preferably antranyl or phenanyl.

4. A method according to claim 1, wherein said reactive group of said derivatizing agent has a formula selected from —NH₂, —NHNH₂, —COOH, —COCl, —CHO, —NCO, and —NCS.

5. A method according to claim 1, wherein said analyte of interest and said derivatizing agent are brought into contact to form a covalent complex between the analyte of interest and the derivatizing agent.

6. A method according to claim 5 said analyte of interest/derivatizing agent covalent complex is brought into contact with said molecularly imprinted polymer, thereby forming a non-covalent complex between the analyte of interest/derivatizing agent complex and the molecularly imprinted polymer.

7. A method according to claim 1, wherein said derivatizing agent and said molecularly Imprinted polymer are brought into contact to form a non-covalent complex between the derivatizing agent and the molecularly imprinted polymer.

8. A method according to claim 7 wherein said derivatizing agent/molecularly imprinted polymer non-covalent complex is brought into contact with said analyte of interest, thereby forming a covalent complex between said analyte of interest and the derivatizing agent moiety of the derivatizing agent/molecularly imprinted polymer non-covalent complex.

9. A method according to claim 5, wherein the analyte of interest/derivatizing agent complex is released from the molecularly imprinted polymer by means of the use of organic solvents and/or acidic or basic pH conditions and/or the use of inorganic salts.

10. A method according to claim 1, wherein the molecularly imprinted polymer is packed into a column.

11. A method according to claim 1, wherein the molecularly imprinted polymer is linked or attached non-covalently or covalently to, or deposited on a surface for analysis by matrix assisted laser desorption ionization mass spectrometry.

12. A method according to claim 1, wherein the molecularly imprinted polymer is linked or attached non-covalently or covalently to a surface for analysis by a quartz crystal microbalance sensor or a surface plasmon resonance sensor or magnetic beads.

13. A method according to claim 1, wherein said derivatized analyte is further concentrated and/or isolated and/or separated by electrocapture.

14. A method according to claim 1, wherein the derivatized analyte is further analyzed by mass spectrometry.

15. A kit for performing the method according to claim 1, said kit comprising a derivatizing agent, which contains a sulphonic group or an analogue thereof and a reactive group for creating a covalent bond between said derivatizing agent and an analyte of interest, and a molecularly imprinted polymer with selective affinity for a sulphonic acid group or an analogue thereof.
